(19) United States
(12) Patent Application Publication
(10) Pub. No.: US 2003/0121147 A1
(43) Pub. Date: Jul. 3, 2003

(54) Method for configuring an electrical connector with keying device and system configured by connectors made therefrom

(76) Inventor: Andrew Cheng, Diamond Bar, CA (US)

Correspondence Address: Andrew Cheng, 22928 Estoril Drive #5, Diamond Bar, CA, 91765, US

(21) Appl. No.: 10/006,873

(22) Filed: Dec. 6, 2001

(51) Int. Cl. H01R 24/00

(52) U.S. Cl. 29/854; 29/857; 439/677; 439/675

(57) ABSTRACT

A method for configuring an electrical connector having a housing comprises the step of, 1) providing at least a pair of silos adapted to be formed on the housing of the connector; 2) providing at least a silo with a key thereon; 3) arranging the silos into different combinations established by events different from one another; and 4) selecting a first event from the combinations for serving configuration of the connector.

### FIELD OF THE INVENTION

The present invention relates to a method, and more particularly to a method for configuring an electrical connector with a keying device and a system configured by the connectors such that connectors with different positions are not intermateable.

### DESCRIPTION OF THE PRIOR ART

Power connectors are required in every computer system. For example, a power supply of a personal computer has at least four cable assemblies for power output, i.e. one for motherboard, one for hard disk drive, one for CD-ROM, and one for floppy disk drive. In some cases, the power supply has more output cable assemblies. Each cable assembly includes a cable end connector having a certain position, which is referred to pins/sockets of the connector. Since there is a possibility of incorrect mating between male and female connectors, it is necessary to provide some device to prevent such mismatch.

U.S. Pat. No. 5,342,221 issued to Peterson on Aug. 30, 1994 discloses a group of electrical connectors in which “at least some of said silos of the male connectors and said receptacles of the female connectors including flattened comers only on said second sides thereof such that either connector in any given said set of connectors cannot mate with a connector of any other set thereof, see last paragraph of claim 1 of the '221 patent. The '221 patent has been further reissued to RE37,296 in which limitation has been added.

This unique keying system is best manifested in FIG. 3 of the '221 patent in which connectors having different positions from different sets are not intermateable.

In addition, according to the Reissue Application of the '221 patent, there is a connector family, Mini-Fit Jr. and Mini-Fit BM1 which are not designed to preclude mating of a connector of one mating set with a connector of another set.

Peterson discloses only a single embodiment, while does not disclose how those connectors shown in FIG. 3 come from. It seems to be unlikely to create another set of connectors different from the first set shown in FIG. 3 according to Peterson's teaching.

On the other hand, Peterson discloses connectors having different positions from different sets are not intermateable. However, Peterson does not disclose how to make connectors with the same positions which are not intermateable.

U.S. Pat. No. 6,022,246 issued to Ko discloses another type of electrical connectors in which connector of different positions can not match with connector with different positions. U.S. Pat. Nos. 6,159,054 and 6,165,024 disclose also the way to prevent incorrect match between connectors with different positions.

None of the prior art patents disclose a method for configuring a set of connector in which connectors with different terminal numbers cannot mate with others. Accordingly, it is needed to provide a genuine method in which the intermateable capability of connectors can be carefully controlled in a scientific and logic way so as to increase the design efficiency as well as productivity.

Referring to FIG. 8, there are two connectors with same positions and each has certain number of silos provided with flattened corners. How to effectively determine whether those two connectors are mateable nor not, the only way is trial and error. Accordingly, there must to have a better way to help the design engineer to do the job efficiently and scientifically.

### SUMMARY OF THE INVENTION

It is an objective of this invention to provide a method to arrange flattened corner of silo such that connector with different terminal number can be configured to prevent incorrect mating with connector having the same terminal numbers from different sets.

It is an objective of this invention to provide a method to arrange flattened corner of silo such that connector with different terminal number can be configured to prevent incorrect mating with connector having the different terminal numbers from different sets.

It is still an objective of this invention in which the connectors which are not intermateable can be easily arranged according a logic such that the design can easily arrange any set of connectors which are not intermateable.

In order to achieve the objectives set forth, a method for configuring an electrical connector in accordance with the present invention having a housing comprises the step of, 1) providing at least a pair of silos adapted to be formed on the housing of the connector; 2) providing at least a silo with a key thereon; 3) arranging the silos into different combinations established by events different from one another; and 4) selecting a first event from the combinations for serving configuration of the connector.

### BRIEF DESCRIPTION OF THE DRAWINGS

Other objects and further features of the present invention will be apparent from the following detailed description when read in conjunction with the accompanying drawings, in which:

FIG. 1 is a first basic silo arrangement in according to the present invention;

FIGS. 2A to 2D are four different family sets of connectors made from first silo arrangement;

FIG. 3A is a second basic silo arrangement in accordance with the present invention;

FIGS. 3B and 3C are two different family set of connector in which different connectors are not intermateable;

FIG. 4 is an illustration of FIG. 3 of RE37,296 represented by the teaching of the present invention;

FIGS. 5A and 5B are connectors configured by the first and second configuring units in accordance with the present invention, as illustrated in Table 4;

FIGS. 5C and 5D are connectors converted from Table 5;

FIG. 6A a third basic silo arrangement arranged in a single row;

FIGS. 6B and 6C are two different family set of connector in which different connectors are not intermateable even each connector carries the same positions;

FIG. 7 is a third silo arrangement in accordance with the present invention;

FIGS. 7A and 7B are connectors configured with the third silo arrangement in which connectors are not mateable in any position; and

FIG. 8 is illustration in which two connectors are shown.

### DETAILED DESCRIPTION OF PREFERRED EMBODIMENT

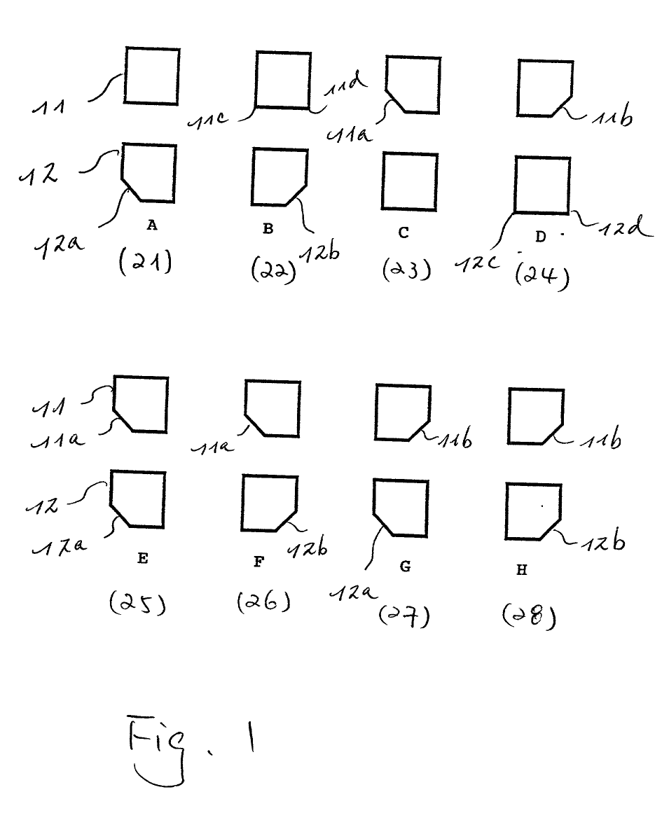

Referring to FIG. 1A, basic configuration units are configured with an upper square 11, and a lower square 12. The corners of the squares 11 and 12 can be selectively flattened in the lower left corners 11a and 12a; and lower tight corners 11a and 12b. Based on these configuration, when the squares 11 and 12 are selectively arranged with and without the flattened corners 11a, 12a, 11b, and 12b, a set of eight different and unique configuration units 21, 22, 23, 24, 25, 26, 27 and 28 can be established. However, in those eight configuration units, not all upper and lower squares 11 and 12 are provided with lower left or right flattened corners 11a, 12a.

It can be readily appreciated that those eight unique configuration units 21, 22, 23, 24, 25, 26, 27 and 28, and when connectors are configured by the configuration units, a plurality of variations can be achieved.

When the configuration units are used to configure connectors which are not intermateable, the working principle of these arrangement is when a rectangular square 11, 12 is try to mate with a receptacle having a corner flattened, a corner of the square 11, 12 will be blocked by the flattened corner 11a. For example, when a plug of configuration unit B is try to mate with a receptacle of configuration unit C, the corner 11c will be blocked by the flattened corner 11a, thereby prevent them from mating from each other.

By this arrangement, the configuration units 21, 22, 23, 24, 25, 26, 27 and 28 can be used to configure connectors with any positions. The position used here is to describe a connector with how many configuration units. If a connector is configured by two configuration units, the connector is referred to have two (2) positions for easy understanding, while a connector configured by eight (8) configuration units is referred to eight (8) positions.

Even those eight (8) units are ready to use for configuring connectors with different positions, it would be naturally confused to a designer to know which unit has been used, or which unit has not been used. For example, in a ten (10) positions or even high positions situation, it will be very difficult to recognize which is which.

In order to scientifically, logically and efficiently use those configuration units 21, 22, 23, 24, 25, 26, 27, and 28 to configure connectors with different positions, each configuration unit is designated with an annotation, i.e.

Unit 21 is represented by “A”; Unit 22 is represented by “B”; Unit 23 is represented by C; Unit 24 is represented by “D”; Unit 25 is represented by “E”; Unit 26 is represented by “F”; Unit 27 is represented by “G”; and Unit 28 is represented by “H”.

By this annotation converting process, the connector represented by those annotations can be easily recognized by the designer no matter the connector has how many positions. Examples are given below for understanding the efficiency of the method of my invention.

TABLE 1

| Con | Pos 1 | Pos 2 | Pos 3 | Pos 4 | Pos 5 | Pos 6 | Pos 7 | Pos 8 | Pos 9 | Pos 10 |
|---|---|---|---|---|---|---|---|---|---|---|
| 31 | A | | | | | | | | | |
| 32 | B | C | | | | | | | | |
| 33 | B | E | F | | | | | | | |
| 34 | B | E | G | H | | | | | | |
| 35 | E | B | F | G | H | | | | | |
| 36 | H | B | D | C | B | H | | | | |
| 37 | B | D | B | D | B | D | E | | | |
| 38 | E | E | E | B | B | B | D | D | | |
| 39 | E | E | B | B | E | C | D | D | E | |
| 40 | H | H | G | G | F | F | E | E | C | C |

Con: Connector; Pos: Position

Table 1 discloses a table showing a set of connectors ranging positions from 31 to 40 are configured. In order to prevent connector 1 from mismate with other connectors, the core of my invention is when unit “A” is selected to configure the connector with a single position, then the unit “A” will not be selected in any other positions in the connectors 32 to 40. By this arrangement, the connector 1 will not be able incorrectly mate with other connectors in any positions.

In order to prevent connector 32, configured by units “BC”, from mismating with other connectors 31, 33 to 40 in any positions, then units “BC” will not be repeatedly selected in any two consecutive positions, i.e. Pos 1,2; Pos 2,3; Pos 3,4; Pos 4,5; Pos 5,6; Pos 6,7; Pos 7,8; Pos 8,9; and Pos 9,10 among those connectors. Accordingly, connector 32 will not be able to mate with any other connectors. This process can be repeatedly processed till all ten connectors are logically configured such that they are not intermateable one another.

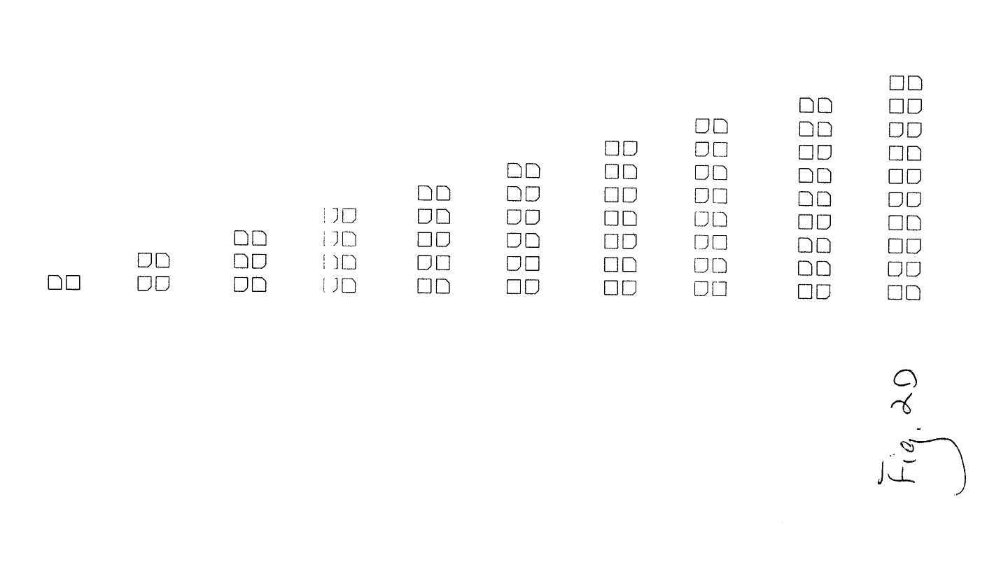

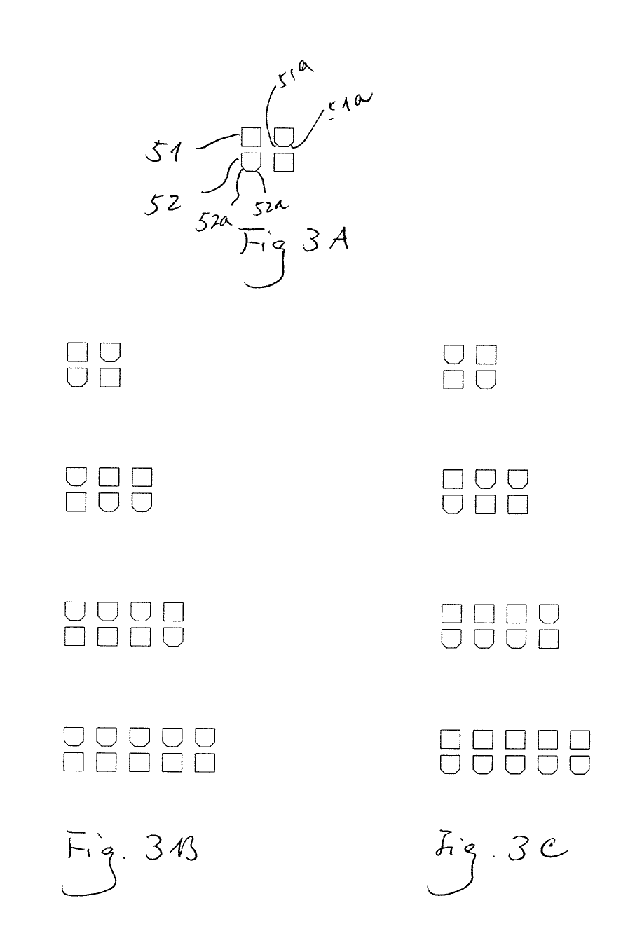

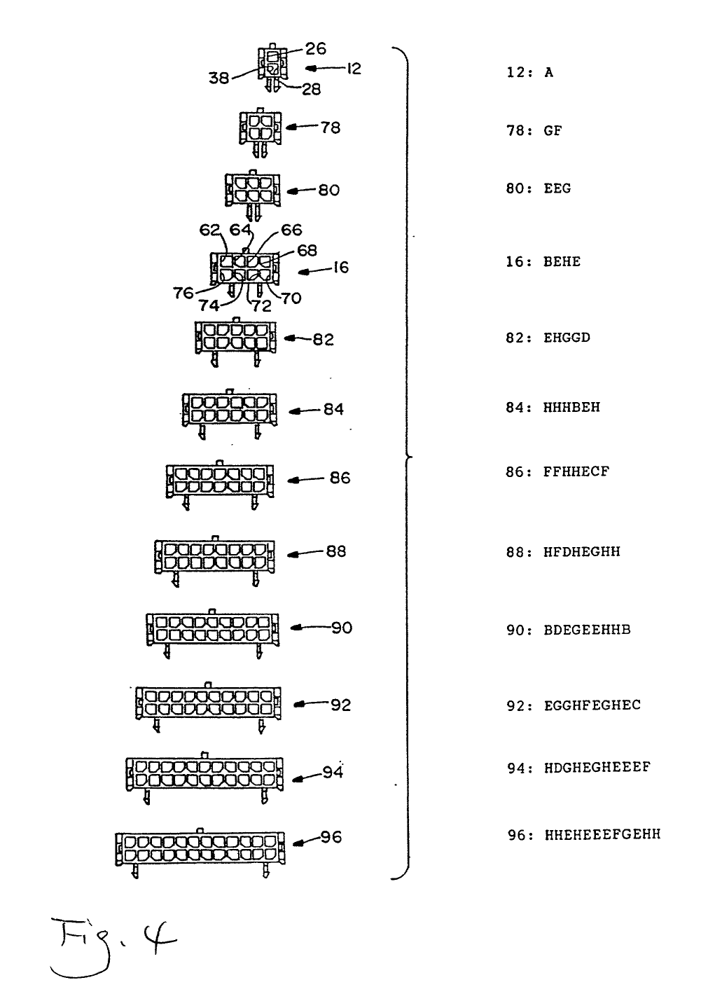

In addition, my invention of converting each configuration units 21, 22, 23, 24, 25, 26, 27, and 28 into corresponding annotations “A, B, C, D, E, F, G, and H” scientifically and logically simplify and decipher the complex of the geometrical combinations created by the configuration units 21, 22, 23, 24, 25, 26, 27, and 28. With my teaching, FIG. 3 of the RE37,296 can be expressed by the following formation, and it is clearly explain why those connectors 12, 78, 80, 16, 82, 84, 86, 88, 90, 92, 95, and 96 are not intermateable, see FIG. 4 of the attached drawings.

Connector 12: A; Connector 78: GF; Connector 80: EEG; Connector 16: BEHE; Connector 82: EHGGD; Connector 84: HHHBEH; Connector 86: FFHHECF; Connector 88: HFDHEGGH; Connector 90: BDEGEEBHHB; Connector 92: EGGHFEGHEC; Connector 94: HDGHEGHEEEFF and Connector 96: HHEHEEEFGEHH.

As a matter of fact, with the teaching of my invention, the designer can arrange a great deal of group of connectors which are not mateable. The following formula can give a typical explanation.

$$Events = {E}^{n} - {{\sum }^{1}}_{i = n - 1} ( n - i + 1 ) {E}^{i}$$

In which:

N: Numbers of positions of connectors;

E: Number of Units used to configure the connector;

Events: All combinations established by all Units in all positions.

The description of Eⁿ means Events configured by all Units in “n” positions.

The description

$$of {{\sum }^{1}}_{i = n - 1} ( n - i + 1 ) {E}^{i}$$

means all repeated Events.

If connectors 31 and 32 are used to establish a family, and we would like to know how many connectors 31, 32 are available for selection, then the above-described formula can be used. Connector 31, it can be easily selected one unit from units “A, B, C, D, E, F, G, and H.” Connector 32, it can be easily selected from any two units from units “A, B, C, D, E, F, G, and H” as long as Connector 31 is not repeated. From the forgoing description, there are totally 48 combinations available for configuration the Connectors 31 and 32.

By my teaching demonstrated above, the design of connectors can scientifically and logically make his/her design without confusion.

Table 2 simply demonstrates how to establish four different set of connector family in which connector with different positions are not mateable. In addition, by my teaching above, even we connectors with same positions can be selected to be not mateable, as explained between connectors 2 in Groups 1 and 2, illustrated in Table 2.

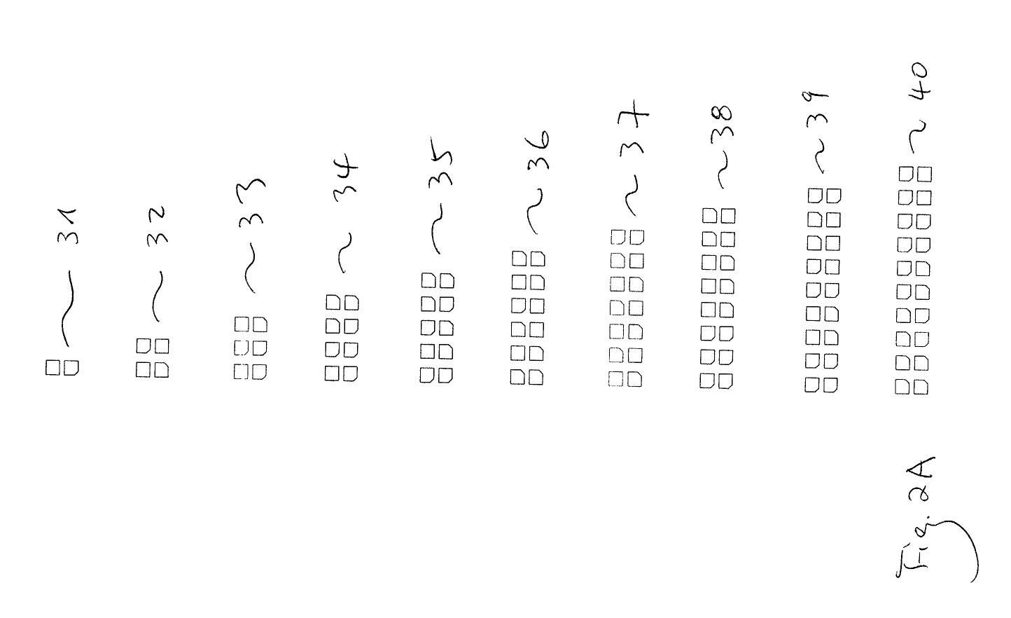

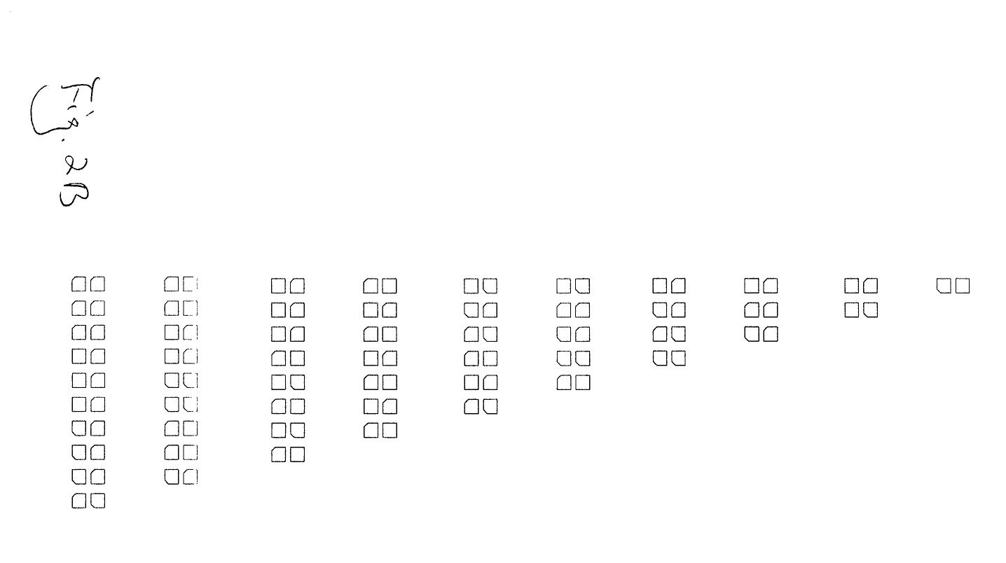

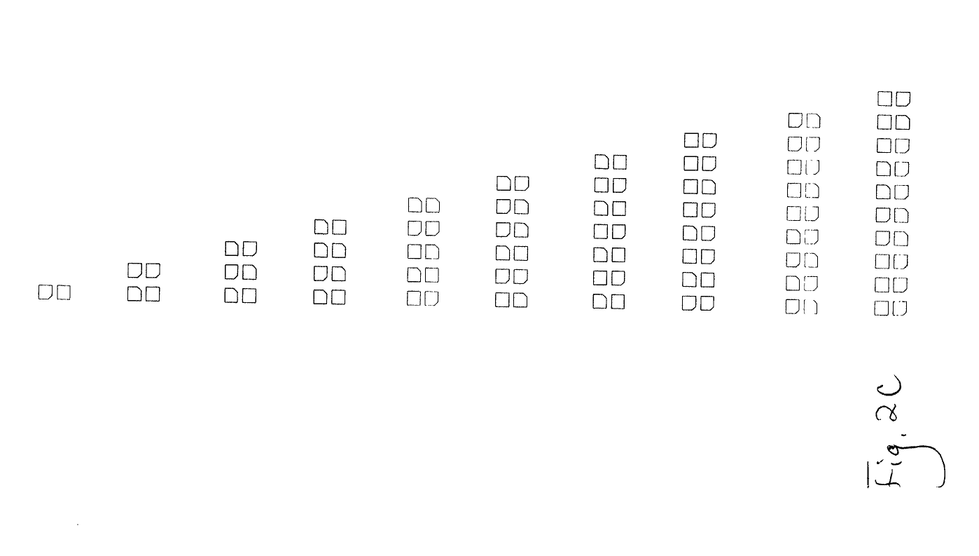

The connector families shown in Table 2 are preferably illustrated from FIGS. 2A to 2D and there are more and more types of connectors which are available for configuring the connectors which are either intermateable or not intermateable.

TABLE 2

| Pos No.\Group | 1^{st} Group | 2^{nd} Group | 3^{rd} Group | 4^{th} Group |
|---|---|---|---|---|
| 1 | A | B | C | D |
| 2 | BC | CD | DE | EF |
| 3 | BEF | CEF | DFG | FGH |
| 4 | BEGH | CFGH | DFHD | FHFE |
| 5 | EBFGH | DEFHA | ADBEH | BCAFE |
| 6 | HBDCBH | DFGACG | BEDFFG | ACFEGH |
| 7 | BDBDBDE | ACACACA | DADADAD | ABABABA |
| 8 | EEEBBBDD | CCCADADA | EDAGABAA | CFCFCFCF |
| 9 | EEBBECDDE | AACCHHAAF | FGFGABAEF | AHHAHHAHH |
| 10 | HHGGFFEECC | EEECCCFFFG | AAAFFGGABA | BEABEABEAB |

However, when those configuration units “A to H” are used to configure the connectors, care should be taken. As it can be apprecitated in FIG. 1, a plug configured by configuration unit E (25) can mate with a receptacle connector configured by a receptacle connector A (21). The same applies to F to B, G to C, and H to D. However, a plug connector made from the configuration units A to D, can not mate with a receptacle connector made from the configuration unit E to F. As a result, when an one-position connector started from E to H, care has to be taken for not repeating configuration units A to D.

For example, in Group 4 of Table 2, the second connector is configured by “EF”, as described above, the second connector configured by “EF” can be received in the seventh connector configured by “ABABABA”. As a result, a loophole is found and which has to be worked out. This loophole is created because those eight configuration units “A to H” are not exclusively unmateable from each other. If we need to over come the loophole happened between second and seventh connectors of the Group 4, then once the configuration units “E to H” are selected, especially when selected in low-position connector, then configuration units “A to D” shall not be selected. Then the loophole can be fixed.

While the configuration units “A, B, C, D, E, F, G and H” are used to configure connectors shown above, another configuration units “X, Y” can be used to configure connectors which are also not intermateable.

Referring to FIGS. 3A, a second basic configuration unit arrangement is configured by an upper square 51, and a lower square 52, while each square 51, 52 are selectively provided with two flattened corners 51a, 52a. Based on these configurations, when the squares 51 and 52 are selectively arranged with and without the flattened corners 51a, 52a, a set of two unique configuration units “X” and “Y” can be established. It can be readily appreciated that those two unique configuration units “X” and “Y” are not mateable if each is made into a connector such as shown in FIG. 1 of RE37,296.

By this arrangement, the configuration units X and Y can be used to configure connectors with limited positions, such as shown in FIGS. 3B and 3C.

Table 3 explanatorily illustrate how to build connectors with the configuration units X and Y. Basically, the working principle behind is identical to the first embodiment.

TABLE 3

| Pos No.\Group | 1^{st} Group | 2^{nd} Group |
|---|---|---|
| 1 | XY | YX |
| 2 | YXX | XYY |
| 3 | YYYX | XXXY |
| 4 | YYYYY | XXXXX |

According to a third embodiment in accordance with my invention, the configuration units A, B, C, D, E, F, G and H, together with configuration units X and Y are both used in configuring the connectors. Table 4 typically illustrate two connectors configured by invention.

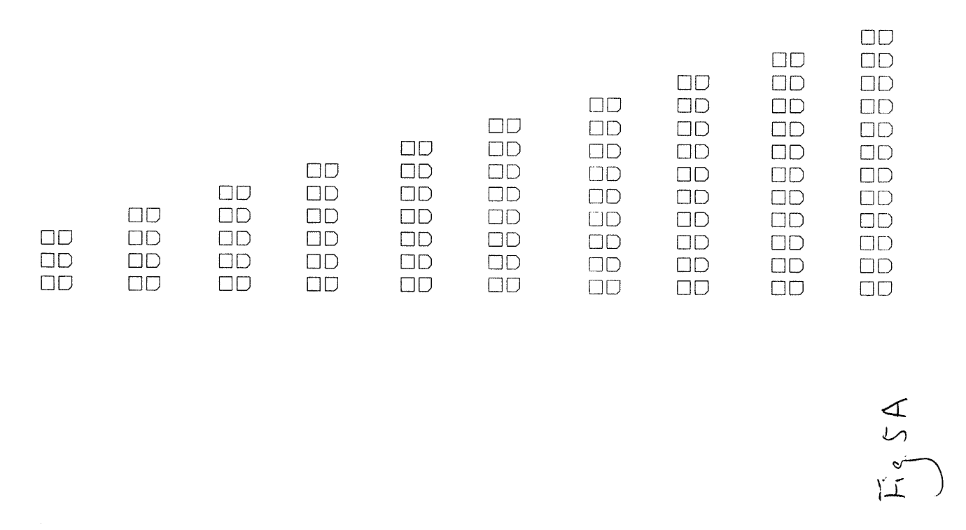

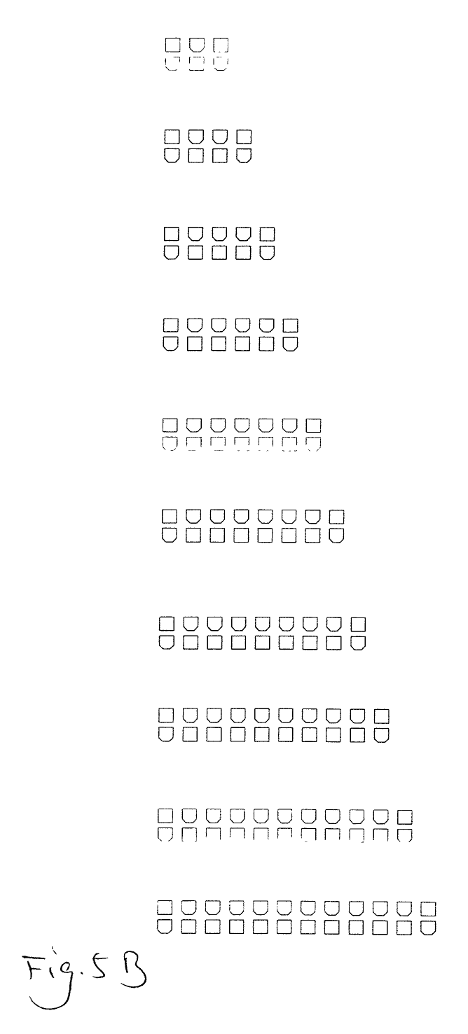

As a matter of fact, the connectors shown in Table 4, FIGS. 5A and 5B, is a unique explanatorily illustration of my invention. In these connectors, the configuration units in first and last positions are kept different with the configuration unit or units located in the positions between the first and last positions. Then the connectors made therefrom are not intermateable. As illustrated, the configuration units located in other positions can be kept identically for easily recognition and design purpose. By this arrangement, the design engineer can scientifically and logically design a plurality set of connectors through the teaching of my invention while without gets confused.

In addition, this idea can be embodied by the configuration units X and Y, such as shown in Table 5, FIGS. 5C and 5D, first Group, or any two configuration units selected from configuration units A to H, such as shown in Table 5, second Group. By the illustration, the scientific and logical method is created to configure connectors

TABLE 4

| Pos No.\Group | 1^{st} Group | 2^{nd} Group |
|---|---|---|
| 3 | AXA | AYB |
| 4 | AXXA | AYYB |
| 5 | AXXXA | AYYYB |
| 6 | AXXXXA | AYYYYB |
| 7 | AXXXXXA | AYYYYYB |
| 8 | AXXXXXXA | AYYYYYYB |
| 9 | AXXXXXXXA | AYYYYYYYB |
| 10 | AXXXXXXXXA | AYYYYYYYYB |
| 11 | AXXXXXXXXXA | AYYYYYYYYYB |
| 12 | AXXXXXXXXXXA | AYYYYYYYYYYB |

TABLE 5

| Pos No.\Group | 1^{st} Group | 2^{nd} Group |
|---|---|---|
| 3 | XYX | ABA |
| 4 | XYYX | ABBA |
| 5 | XYYYX | ABBBA |
| 6 | XYYYYX | ABBBBA |
| 7 | XYYYYYX | ABBBBBA |
| 8 | XYYYYYYX | ABBBBBBA |
| 9 | XYYYYYYYX | ABBBBBBBA |
| 10 | XYYYYYYYYX | ABBBBBBBBA |
| 11 | XYYYYYYYYYX | ABBBBBBBBBA |
| 12 | XYYYYYYYYYYX | ABBBBBBBBBBA |

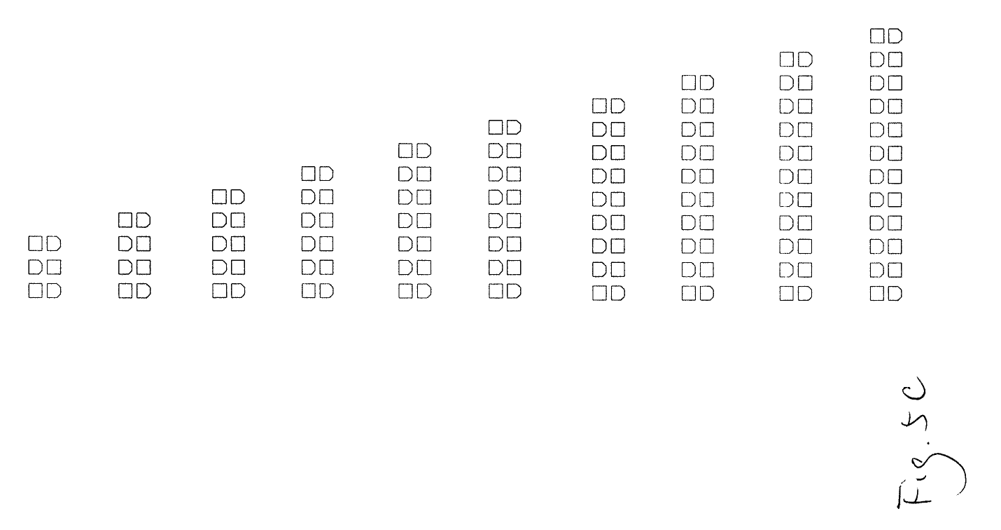

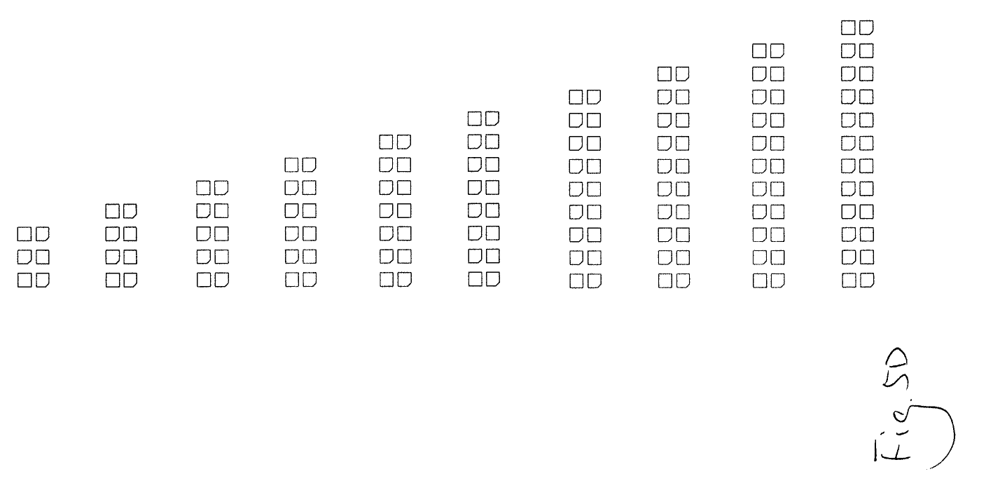

The embodiments and illustrations described above demonstrate that the configuration unit includes the upper and lower silos, i.e. squares 11 and 12. However, based on my invention, the configuration unit can be embodied in a single row, i.e. only a single square 90 is used, as shown in FIGS. 6A to 6C. Based on the idea described above, the connectors shown in FIGS. 6B and 6C are also not intermateable even having the same positions.

According to my invention, the silos or configuration units 91, 92, 93 and 94 each having a flattened corner 91a, 92a, 93a and 94a. The flattened corners 91a, 92a, 93a, and 94a are arranged such that each unit 91, 92, 93 and 94 can exclusively mate with only itself, while other are blocked to mate because at least a corner is blocked by a flattened corner 91a, 92a, 93a and 94a. As a result, this unique can be used for design a connector.

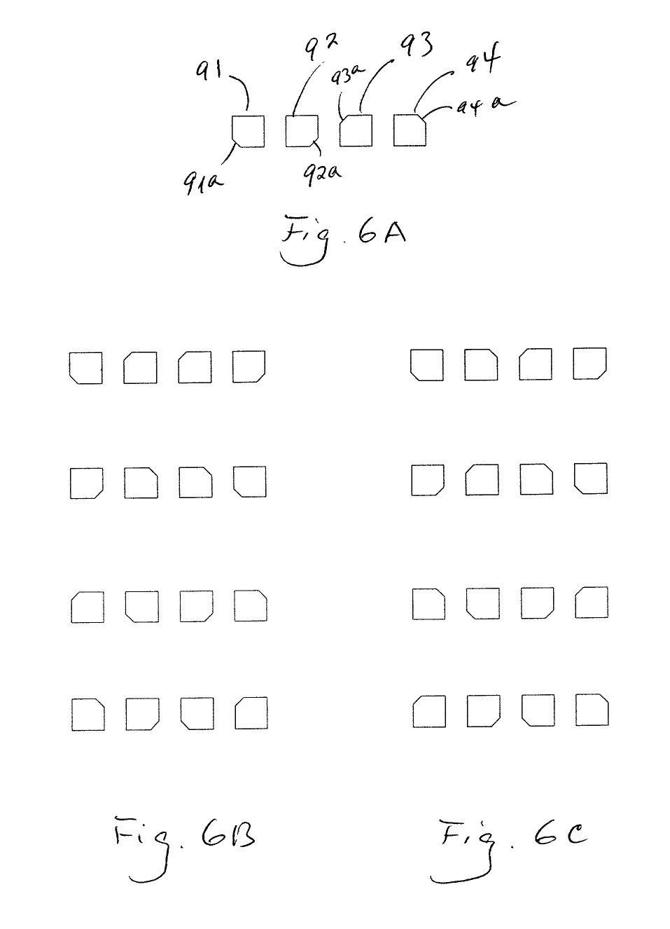

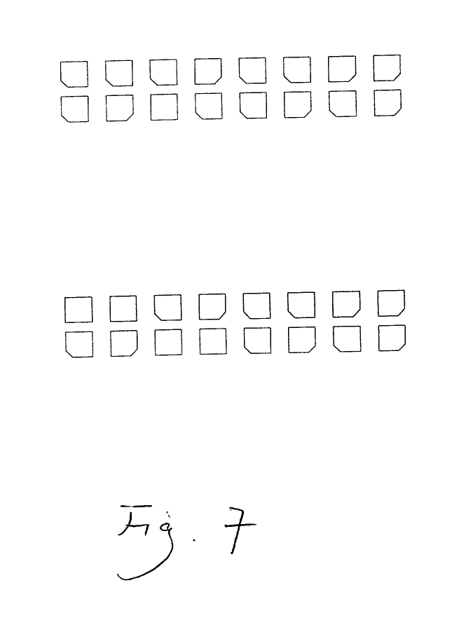

Again, the geometrical structure can be easily represented by Table 6 which makes easy recognition of why those four connectors are not intermateable. The designer can easily make their design without any complicated process. The unit 91 is represented by “N”; the unit 92 is represented by “O”, the unit 93 is repressed by “P”; and the unit 94 is represent by “Q”. By this arrangement, the structural arrangement in FIGS. 7A and 7B can be expressed by Table 6.

TABLE 6

| Pos No.\Group | 1^{st} Group | 2^{nd} Group |
|---|---|---|
| 1 | NPPO | NQPO |
| 2 | OPPN | OPQN |
| 3 | PNOQ | QNOP |
| 4 | QNOP | PONQ |

This implementation can be embodied in the existing personal computer system. The power supply installed in the personal computer powers at least a CD-ROM, a hard disk drive, a floppy disk drive, and a motherboard. The existing power connectors used have only a single and all bear the same configuration. By the provision of the present invention, each electronic device described above can be provided with a designated connector and incorrect intermating therebetween can be avoided.

Referring to FIG. 7, a third basic configuration units are configured with an upper square 111, and a lower square 112. The corners of the squares 111 and 112 can be selectively flattened in 111a, 111b, 111c, and 111d; 112a, 112b, 112c and 112d. Based on these configuration, when the squares 111 and 112 are selectively arranged with and without the flattened corners 111a, 111b, 111c, and 111d; 112a, 112b, 112c and 112d, a set of sixteen different and unique configuration units 211, 212, 213, 214, 215, 216, 217, 218, 219, 220, 221, 222, 223, 224, 225, and 226 can be established. These sixteen unique configuration units 211, 212, 213, 214, 215, 216, 217, 218, 219, 220, 221, 222, 223, 224, 225, and 226 are exclusively mateable only with itself, i.e. any two configuration units are non-mateable. Accordingly, when those configuration units are used to configure connector such as shown in Table 2 and FIGS. 2A to 2D, as long as follow the principle of my invention, the mating problem between the second connector and the seventh connector in Group 4 will never be happened.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

I claim:

1. A method for configuring an electrical connector having a housing, comprising the step of:
1) providing at least a pair of silos adapted to be formed on the housing of the connector;
2) providing each silo with a key thereon;
3) arranging the silos into different combinations established by events different from one another; and
4) selecting a first event from the combinations for serving configuration of the connector.

2. The method as recited in claim 1, wherein the silo has a rectangular cross section.

3. The method as recited in claim 2, wherein the key is a flattened corner of the silo.

4. The method as recited in claim 2, wherein the silo has two flattened corners located in a lower side of the silo.

5. The method as recited in claim 1, wherein the silos are arranged in upper and lower arrangement.

6. A method for configuring an electrical connector system including first male and female connectors, and second male and female connectors, comprising the step of:
1) providing at least a pair of silos adapted to be formed on housings of the first and second male connectors, each silo provided with first key and the silos being arranged into first group combination established by male events different from one another;
2) selecting the first male connector from a first male event from the first group combination, and the second male connector from the second male event from the first group combination;
3) providing at least a pair of receptacles adapted to be defined in housings of the first and second female connectors, one of the receptacles provided with second key corresponding to the first key of the silos and the receptacles being arranged into second group combination by female events different from one another; and
4) selecting the first female connector from a first female event from the second group combination, and the second female connector from the second female event combination from the second group combination, wherein the first male connector can only be mated with first female connector, while is not intermateable with the second female connector.

7. A method for configuring an electrical connector system, comprising the step of:
1) providing a set of elementary configuration unit suitable for establishing a plurality of combinations;
2) designating each elementary configuration unit an annotation; and
3) representing the connector by the annotations.

8. A method for configuring an electrical connector system in which different connectors are not mateable, comprising the step of:
1) providing a set of elementary configuration unit suitable for establishing a plurality of combinations;
2) designating each elementary configuration unit an annotation; and
3) representing the connector by the annotations in which a first annotation for a first connector is not repeated in a second annotation of a second connector.

9. A method for configuring an electrical connector system in which connectors with different positions are not mateable, comprising:
1) providing a set of elementary configuration unit suitable for establishing a plurality of combinations;
2) selecting at least two configuration units to configure the connector having at least three positions; and
3) wherein the configuration units located in first and last positions are selected to be different to the configuration units located at other positions.

10. A method for configuring an electrical connector, comprising:
1) providing a set of elementary configuration unit suitable for establishing a plurality of combinations;
2) selecting at least two configuration units to configure the connector having at least three positions; and
3) wherein the configuration units located in first and last positions are selected to be different to the configuration units located at other positions.
